(19) United States
(12) Patent Application Publication
(10) Pub. No.: US 2012/0010829 A1
(43) Pub. Date: Jan. 12, 2012

(54) Fault diagnosis method, fault diagnosis apparatus, and computer-readable storage medium

(75) Inventor: Izumi Nitta, Kawasaki (JP)

(73) Assignee: FUJITSU LIMITED, Kawasaki (JP)

(21) Appl. No.: 13/067,246

(22) Filed: May 18, 2011

(30) Foreign Application Priority Data
Jul. 6, 2010 (JP) 2010-154215

(51) Int. Cl. G06F 19/00

(52) U.S. Cl. 702/58

(57) ABSTRACT

A fault diagnosis may perform a statistical analysis based on a fault report of a semiconductor device, in order to output a feature that becomes the cause of the fault depending on a contribution of the feature to the fault. A process of grouping circuit information of the semiconductor device into N groups using one kind of feature as an index may be performed for K kinds of features, in order to group the circuit information into K×N groups. A sum total of feature quantities of partial circuits belonging to each of the groups may be output in a form of a list of learning samples.

### CROSS-REFERENCE TO RELATED APPLICATIONS

This application is based upon and claims the benefit of priority of the prior Japanese Patent Application No. 2010-154215, filed on Jul. 6, 2010, the entire contents of which are incorporated herein by reference.

### FIELD

The present invention relates to a fault diagnosis method, a fault diagnosis apparatus, and a computer-readable storage medium that stores a program which, when executed by a computer, causes the computer to perform a fault diagnosis process.

### BACKGROUND

A shipment test of a semiconductor device such as a LSI (Large Scale Integrated circuit) is performed after the design and fabrication thereof. When a fault is detected by the shipment test, a fault (or failure) analysis using a logic simulation or a fault event is performed in order to extract fault candidates. Based on the fault candidates, causes of the fault are narrowed down by volume diagnosis that performs a statistical analysis. The fault candidates related to the narrowed down causes of the fault are selected, and the cause of the fault is specified by performing a physical analysis using an electron microscope or the like and checking whether the fault is generated in the actual semiconductor device. The specified cause of the fault is fed back to at least one of the design of the semiconductor device and the fabrication process of the semiconductor device, in order to make modifications that may reduce the faults detected by the shipment test.

The fault diagnosis estimates the fault location within the semiconductor device in which the fault is detected by the shipment test performed after fabrication of the semiconductor device. Recently, techniques have been proposed to further narrow down the causes of the fault or to estimate the fault location, using the statistical analysis of the volume diagnosis.

The cost of the physical analysis is increasing due to scaling down and microfabrication of elements and large scale integration of circuits. In order to reduce the cost of the physical analysis and to quickly specify the cause of the fault (or failure), the fault candidates that become physical analyzing targets must be accurately narrowed down by the volume diagnosis.

A volume diagnosis that performs a statistical analysis based on a fault report of the semiconductor device input from a fault analyzing tool, and outputs features that become the causes of the fault depending on contributions to the fault has been proposed in M. Sharma et al., “Efficiently Performing Yield Enhancements by Identifying Dominant Physical Root Cause from Test Fail Data” International Test Conference 2008, Paper 14.3, pp. 1-9, for example. The fault report includes information of nets or input and output pins that are the fault candidates, and may include the fault type such as an open-circuit fault and a bridge fault. Generally, the volume diagnosis receives a fault list of the features that become the fault candidates or, such a fault list is provided in advance within a diagnosis apparatus. The features that become the fault candidates include layout information, such as a wiring length, a number of vias, and a wiring density, and a wiring pattern that becomes the cause of the open-circuit fault or the bridge fault. The proposed volume diagnosis focuses on one kind of feature, sorts the focused features of the circuit information, such as the net list, in a descending order starting from the feature having the largest feature quantity, and equally groups the features into a plurality of groups starting from the feature having the largest feature quantity. An anticipated value of the number of faults and the measured value are computed for each group. The anticipated value may be computed based on the feature quantity of the focused feature using a model formula. On the other hand, the measured value is computed by counting the number of fault candidates included in each group in the fault list. Further, the contribution of the one kind of focused feature to the fault is computed from how close distributions of the anticipated values and the measured values are. The above described process is repeated for all of the kinds of the features, in order to compute the contribution of each kind of feature to the fault and to narrow down the cause of the fault to the kind of feature having the highest contribution.

From the point of view of improving the accuracy with which the causes of the fault are narrowed down in the proposed volume diagnosis, the number of groups into which the circuit information is grouped is preferably large. However, in a case in which the number of fault candidates within the fault report input from the fault analyzing tool is relatively small, the large number of groups will increase the number of groups that include no fault candidates or, the increase the number of groups in which the number of fault candidates is relatively small. Consequently, the accuracy of the statistical analysis may deteriorate in such a case. The case in which the number of fault candidates is relatively small refers to a case in which the number of fault candidates is several tens of nets in the circuit information amounting to several million nets, for example, and data of the fault candidates may be regarded as noise. In addition, the case in which the number of fault candidates is relatively small is caused by a relatively small number of faults within the actual semiconductor device or, a relatively small number of semiconductor devices that are fabricated due to a startup period of the semiconductor device fabrication process or, limited fault information related to the semiconductor device available from a manufacturer due to the semiconductor device being designed and fabricated by a separate organization.

On the other hand, from the point of view of reducing the number of groups including no fault candidates or the number of groups including a relatively small number of fault candidates, the number of groups into which the circuit information is grouped is preferably small. However, when the number of groups is small, it means that the number of samples that become targets of the statistical analysis becomes small. Consequently, the small number of samples causes the accuracy of the statistical analysis to deteriorate.

Therefore, according to the conventional fault diagnosis, there was a problem in that the accuracy of the statistical analysis deteriorates when the number of fault candidates obtained from the fault report of the semiconductor device is relatively small.

### SUMMARY

Accordingly, it is an object in at least one embodiment to provide a fault diagnosis method, a fault diagnosis apparatus, and a computer-readable storage medium, which may suppress accuracy deterioration of the statistical analysis.

According to one embodiment, a fault diagnosis method to be implemented in a computer to execute a fault diagnosis of a semiconductor device to perform a statistical analysis based on a fault report including information of nets or input and output pins that become fault candidates, and features that become fault candidates, includes a first process causing the computer to perform a process of grouping circuit information of the semiconductor device into N (N is a natural number greater than or equal to 2) groups using one kind of feature as an index, for K (K is a natural number greater than or equal to 2) kinds of features, in order to group the circuit information into K×N groups, and to compute a sum total of feature quantities of partial circuits belonging to each of the groups and to output a computed result in a form of a list of learning samples; and a second process causing the computer to perform a learning process based on the list of the learning samples in order to compute a contribution of each feature to the fault, and to compute a ranking of the features having the contribution greater than or equal to a predetermined value in order to output and store in a storage part cause-of-fault information that includes the causes of the fault and indicate the ranking of the features.

According to one embodiment, a fault diagnosis apparatus configured to execute a fault diagnosis of a semiconductor device to perform a statistical analysis based on a fault report including information of nets or input and output pins that become fault candidates, and features that become fault candidates, includes a processor; and a storage part configured to store data and at least a program to be executed by the processor, wherein the processor includes a first unit configured to perform a process of grouping circuit information of the semiconductor device into N (N is a natural number greater than or equal to 2) groups using one kind of feature as an index, for K (K is a natural number greater than or equal to 2) kinds of features, in order to group the circuit information into K×N groups, and to compute a sum total of feature quantities of partial circuits belonging to each of the groups and to output a computed result in a form of a list of learning samples; and a second unit configured to perform a learning process based on the list of the learning samples in order to compute a contribution of each feature to the fault, and to compute a ranking of the features having the contribution greater than or equal to a predetermined value in order to output and store in the storage part cause-of-fault information that includes the causes of the fault and indicate the ranking of the features.

According to one embodiment, a non-transitory computer-readable storage medium which stores a program which, when executed by a computer, causes the computer to execute a fault diagnosis of a semiconductor device to perform a statistical analysis based on a fault report including information of nets or input and output pins that become fault candidates, and features that become fault candidates, and the fault diagnosis includes a first procedure causing the computer to perform a process of grouping circuit information of the semiconductor device into N (N is a natural number greater than or equal to 2) groups using one kind of feature as an index, for K (K is a natural number greater than or equal to 2) kinds of features, in order to group the circuit information into K×N groups, and to compute a sum total of feature quantities of partial circuits belonging to each of the groups and to output a computed result in a form of a list of learning samples; and a second procedure causing the computer to perform a learning process based on the list of the learning samples in order to compute a contribution of each feature to the fault, and to compute a ranking of the features having the contribution greater than or equal to a predetermined value in order to output and store in a storage part cause-of-fault information that includes the causes of the fault and indicate the ranking of the features.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram for explaining a semiconductor fault analysis process;

FIG. 2 is a flow chart for explaining a fault analysis, a volume diagnosis, and a physical analysis;

FIG. 3 is a block diagram illustrating an example of a computer system;

FIG. 4 is a flow chart for explaining a fault diagnosis method in an embodiment of the present invention;

FIG. 5 is a flow chart for explaining an example of a process of a step S11 illustrated in FIG. 4 in more detail;

FIG. 6 is a diagram illustrating an example of a data structure of a fault report;

FIG. 7 is a diagram illustrating an example of a data structure of a learning sample list;

FIG. 8 is a diagram illustrating an example of net lists each of which has two feature quantities;

FIG. 9 is a diagram for explaining an example of generating 6 (3×2) groups from net lists in FIG. 8;

FIGS. 10A, 10B, and 10C are plan views illustrating regions of dies on a wafer;

FIG. 11 is a diagram for explaining the number of generated faults computed in a case in which the grouping is performed according to a second example;

FIG. 12 is a diagram for explaining the grouping of the net lists according to a wiring density;

FIG. 13 is a diagram illustrating an example of the number of fault net lists and the net IDs of the fault net lists included in the groups obtained by the grouping;

FIG. 14 is a flow chart for explaining an example of a process of a step S12 illustrated in FIG. 4 in more detail;

FIG. 15 is a diagram illustrating an example of cause-of-fault information;

FIG. 16 is a diagram illustrating another example of the cause-of-fault information;

FIG. 17 is a flow chart for explaining another example of the process of the step S11 illustrated in FIG. 4 in more detail; and

FIG. 18 is a diagram illustrating an example of the cause-of-fault information.

### DESCRIPTION OF EMBODIMENTS

Preferred embodiments of the present invention will be described with reference to the accompanying drawings.

According to one embodiment, a fault diagnosis may perform a statistical analysis based on a fault report of a semiconductor device input from a fault analyzing tool that uses a logic simulation of a fault event, in order to output a feature that becomes the cause of the fault depending on a contribution of the feature to the fault. A process of grouping circuit information of the semiconductor device into N (N is a natural number greater than or equal to 2) groups using one kind of feature as an index may be performed for K (K is a natural number greater than or equal to 2) kinds of features, in order to group (or divide) the circuit information into K×N groups. A sum total of feature quantities of partial circuits belonging to each of the groups may be computed, and a computed result may be output in a form of a list of learning samples. The contribution of each feature to the fault may be computed by a learning process based on the list of the learning samples.

A description will now be given of the fault diagnosis method, the fault diagnosis apparatus, and the computer-readable storage medium in each embodiment according to the present invention.

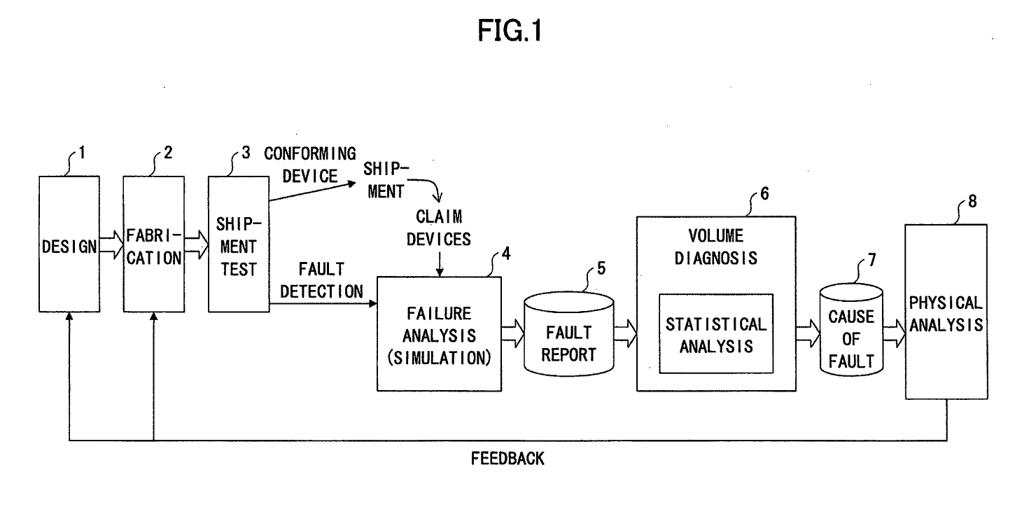

First, a description will be given of a fabrication process of a semiconductor device, such as a LSI, including design, fabrication, test, and analysis, by referring to FIG. 1. FIG. 1 is a diagram for explaining the semiconductor fault analysis process.

The semiconductor device is designed in a design process 1, in order to generate circuit information, such as net lists and layout information. A fabrication process 2 fabricates the semiconductor device based on the circuit information of the semiconductor device designed in the design process 1. A shipment test process 3 performs a known shipment test with respect to the fabricated semiconductor device. If no fault is detected by the shipment test, the semiconductor device is shipped as a conforming device. On the other hand, information of the semiconductor device in which a fault is detected by the shipment test or, information of a claim device in which a deficiency is detected during operation of the semiconductor device that was shipped as a conforming device, is notified to a fault analyzing process 4. The fault analyzing process 4 extracts fault candidates by performing a fault analysis by a fault analyzing tool using a known logic simulation or fault event, in order to generate a fault report 5. The fault report 5 includes information of the nets or input and output pins that become the fault candidates, and may include a fault type such as an open-circuit fault and a bridge fault.

A volume diagnosis process 6 narrows down the causes of the fault by a volume diagnosis that performs a statistical analysis, based on the circuit information, the fault report 5, and the features that become the causes of the fault. The features that become the cases of the fault may include a wiring length, a number vias, a wiring density, and a wiring pattern that causes the open-circuit fault or the bridge fault within the semiconductor device. A physical analyzing process 8 performs a known physical analysis using an electron microscope or the like to check whether the fault is generated in the actual semiconductor device, based on cause-of-fault information 7 including the fault candidates of the narrowed down causes of the fault, in order to specify the cause of the fault. The specified cause of the fault is fed back to at least one of the design process 1 and the fabrication process 2, in order to make modifications in at least one of the design and the fabrication process that may reduce the faults detected by the shipment test.

The processes of the design process 1, the fabrication process 2, the shipment test process 3, the fault analyzing process 4, and the physical analyzing process 8 may be executed according to known procedures, and a detailed description thereof will be omitted.

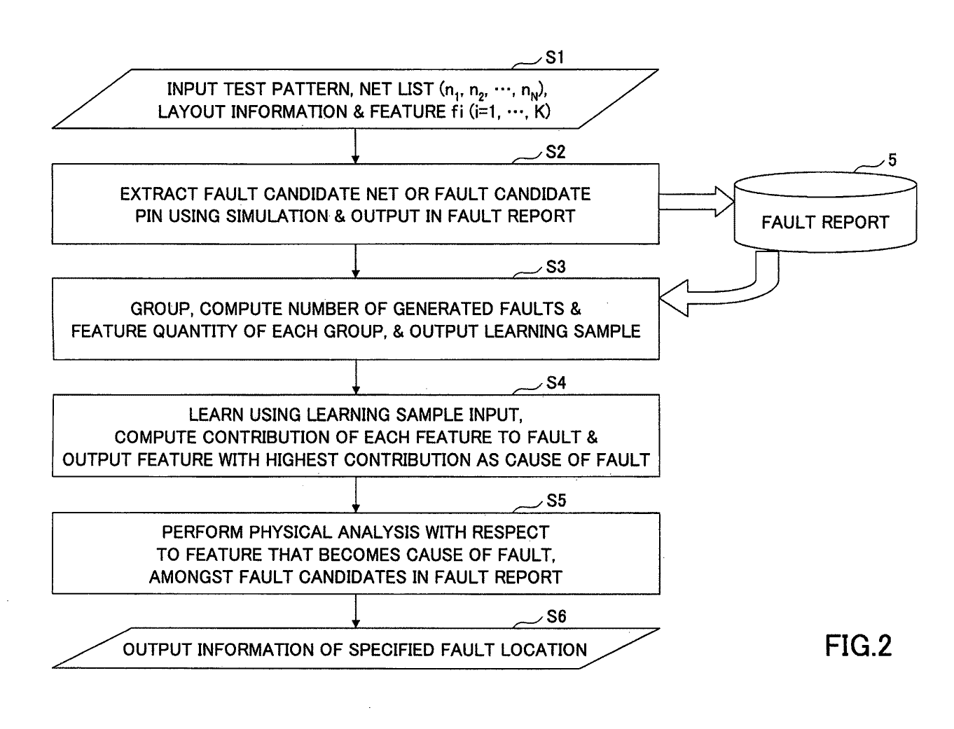

FIG. 2 is a flow chart for explaining the fault analysis, the volume diagnosis, and the physical analysis. The process illustrated in FIG. 2 is executed by the fault analyzing process 4, the volume diagnosis process 6, and the physical analyzing process 8. In FIG. 2, steps S1 and S2 are executed by the fault analyzing process 4, steps S3 and S4 are executed by the volume diagnosis process 6, and steps S5 and S6 are executed by the physical analyzing process 8.

The step S1 inputs test information used for the shipment test in the shipment test process 3, and the circuit information of the semiconductor device that is the target of the shipment test, to a computer that executes the fault analyzing process 4. In this example, the test information includes data of a test pattern input to the semiconductor device. In addition, the circuit information includes net lists (n₁, n₂, . . . , n_{N}), layout information, and features fi (i=1, . . . , K). The step S2 extracts the fault candidates by the fault analysis using the logic simulation or the fault event, based on the test information and the circuit information input to the computer that executes the fault analyzing process 4, and generates and outputs the fault report 5 including information of the nets or input and output pins that become the fault candidates. The fault report 5 that is output is stored in a storage part, which may be provided within the computer that executes the fault analyzing process 4 or, may be externally connected to this computer.

The step S3 groups (or divides) the net lists into N groups according to specified features, by a computer that executes the volume diagnosis process 6. In addition, the step S3 computes the number of fault candidates in each group from the fault report 5, and computes the feature quantities of the features of each group from the layout information, in order to output the computed results as learning samples. The step S4 performs a learning process by the computer that executes the volume diagnosis process 6 based on the learning samples that are input, in order to compute the contribution of each feature to the fault and to output the features having a relatively high contribution as the cause-of-fault information 7. The steps S3 and S4 perform the statistical analysis, and the learning samples and the cause-of-fault information 7 may be stored in the storage part. The computer that executes the fault analyzing process 4 and the computer that executes the volume diagnosis process 6 may be formed by the same computer.

The step S5 performs a physical analysis with respect to the fault candidates having the feature that becomes the cause of the fault, from among the fault candidates included in the fault report 5, in order to judge whether the fault is generated in the actual semiconductor device. The step S6 outputs information of the fault location specified by the physical analysis, and feeds back this information to at least one of the design process 1 and the fabrication process 2. The information of the fault location specified by the physical analysis may be stored in the storage part.

In one embodiment, the fault diagnosis apparatus may be formed by a known general-purpose computer or computer system that includes a storage part such as a memory and a processor such as a CPU (Central Processing Unit). In this case, the storage part stores a program (or fault diagnosis program) that causes the processor (or computer) to execute procedures of at least a fault diagnosis method (or fault diagnosis process) to cause the processor (or computer) to function as each means of the fault diagnosis apparatus or, to realize each function of the fault diagnosis apparatus. This program may be stored in a suitable computer-readable storage medium that is tangible or non-transitory. The fault diagnosis program executes the process of the volume diagnosis process 6, however, the fault diagnosis program may be included in a program that executes the process of at least one of the design process 1, the shipment test process 3, and the fault analyzing process 4.

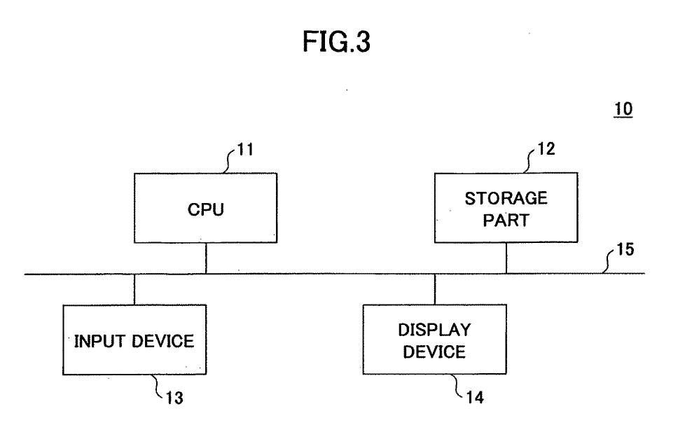

FIG. 3 is a block diagram illustrating an example of the computer system. A computer system 10 illustrated in FIG. 3 includes a CPU 11, a storage part 12, an input device 13, and a display device 14 that are connected via a bus 15. The CPU 11 executes one or more programs stored in the storage part 12 in order to control the entire computer system 10. The storage part 12 may be formed by a semiconductor memory device, a magnetic recording medium an optical recording medium, a magneto-optic recording medium, and the like. The storage part 12 stores one or more programs and various data, and also functions as a temporary memory to temporarily store intermediate results, computation result, and the like of computations and operations executed by the CPU 11. The storage part 12 may be formed by a plurality of storage units or devices. In addition, the program may be installed into the storage part 12 from an external apparatus (not illustrated) that is connected to the computer system 10 via a network (not illustrated). In a case in which the computer system 10 communicates with the external apparatus via the network, an interface part (not illustrated) that is connected to both the network and the bus 15 may be additionally provided in the computer system 10. The input device 13 may be formed by a keyboard or the like. The display device 14 may display messages that urge an operator (or user) to input data or instructions to the computer system 10, and the cause-of-fault information 7 and the like obtained by the statistical analysis. The input device 13 and the display device 14 may be integrally provided in an input and output device, such as a touch-screen panel, that has the functions of both an input device and a display device.

Of course, the connection of the CPU 11, the storage part 12, the input device 13, and the display device 14 is not limited to a bus connection using the bus 15.

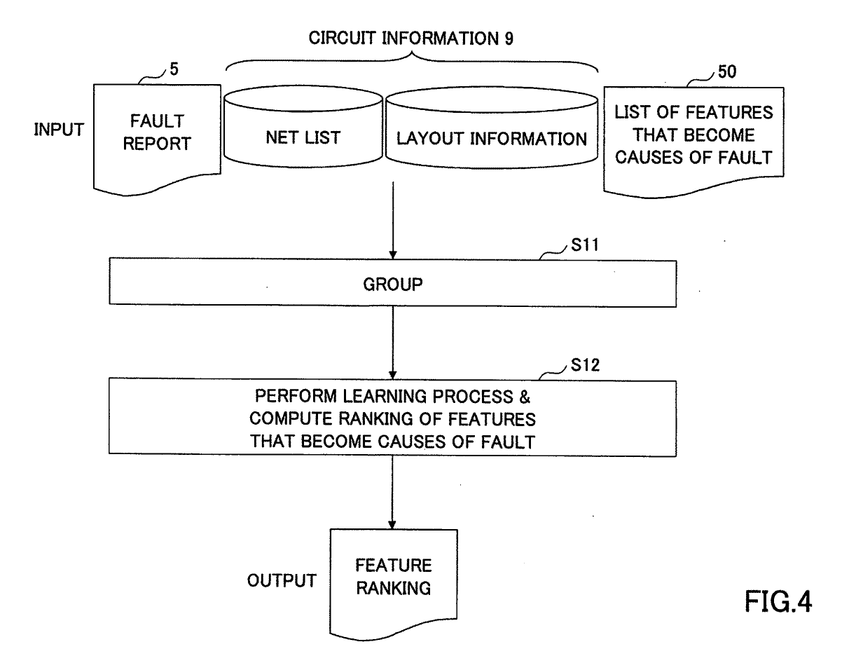

FIG. 4 is a flow chart for explaining the fault diagnosis method in an embodiment of the present invention. The procedures illustrated in FIG. 4 may be executed when the CPU 11 executes the program stored in the storage part 12. In this example, the statistical analysis is based on inputs of the fault report 5, circuit information 9 including the net lists and the layout information, and a feature list 50 of the features that become the cause of the fault. In a case in which the information of the feature that become the cause of the fault may not be specified by the feature list 50, it is possible to use a feature list of the features that become the cause of the fault, that is included or embedded in advance in the program. The fault report 5, the circuit information 9, and the feature list 50 may be input directly to the computer system 10 from the fault analyzing process 4. Alternatively, the fault report 5, the circuit information 9, and the feature list 50 may once be stored in the storage part 12 of the computer system 10 by the fault analyzing process 4, and then read from the storage part 12 by the CPU 11. In addition, the statistical analysis outputs the cause-of-fault information 7 that includes the fault candidates of the narrowed down causes of the fault, and indicate a ranking of the features having a relatively high contribution to the fault.

A step S11 performs a process of grouping the circuit information 9 of the semiconductor device into N (N is a natural number greater than or equal to 2) groups using, as an index, one kind of feature in the feature list 50 of the features that become the causes of the fault, for K (K is a natural number greater than or equal to 2) kinds of features, in order to group (or divide) the circuit information 9 into K×N groups. In addition, the step S11 computes the number of fault candidates in each group generated from the fault report 5, and computes a sum total of the feature quantities of partial circuits belonging to each of the groups from the circuit information 9 and the fault report 5, in order to output the computed results in a form of a list of learning samples. The same fault candidate may overlap amongst different groups and be included in the count of the number of fault candidates. The list of learning samples may be stored in the storage part 12.

Generally, there is a technique which performs a random grouping a plurality of times. According to such a technique, however, there is a relatively high possibility of forming a plurality of similar groups. On the other hand, in a case in which the grouping is performed using, as the index, one kind of feature that becomes the cause of the fault, there is a high possibility that the grouping will be performed so that the distributions of the feature quantities differ amongst the groups. Furthermore, by performing the grouping for a plurality of kinds of features, a large number of groups having different tendencies may be generated, to thereby improve the accuracy of the statistical analysis. Hence, by performing the grouping of the step S11 by setting the value of N to a relatively small value and setting the value of K to a relatively large value, the accuracy of the statistical analysis may be prevented from deteriorating in a case in which the number of fault candidates is relatively small.

A step S12 performs a known learning process based on the list of learning samples, to compute the contribution of each feature to the fault, and to compute ranking of the features having a relatively high contribution, in order to output the cause-of-fault information 7 including the narrowed down causes of the fault and indicating the ranking of the features having the relatively high contribution to the fault. For example, the learning process may utilize a technique such as the SVM (Support Vector Machine). In addition, the learning process may extract a set of samples having a goodness of fit between the predicted value and the measured value of the number of generated faults that is greater than or equal to a predetermined value, amongst the groups generated in the step S11, in order to improve the accuracy of extracting the fault candidates and to improve the accuracy of the statistical analysis. The cause-of-fault information 7 may be stored in the storage part 12.

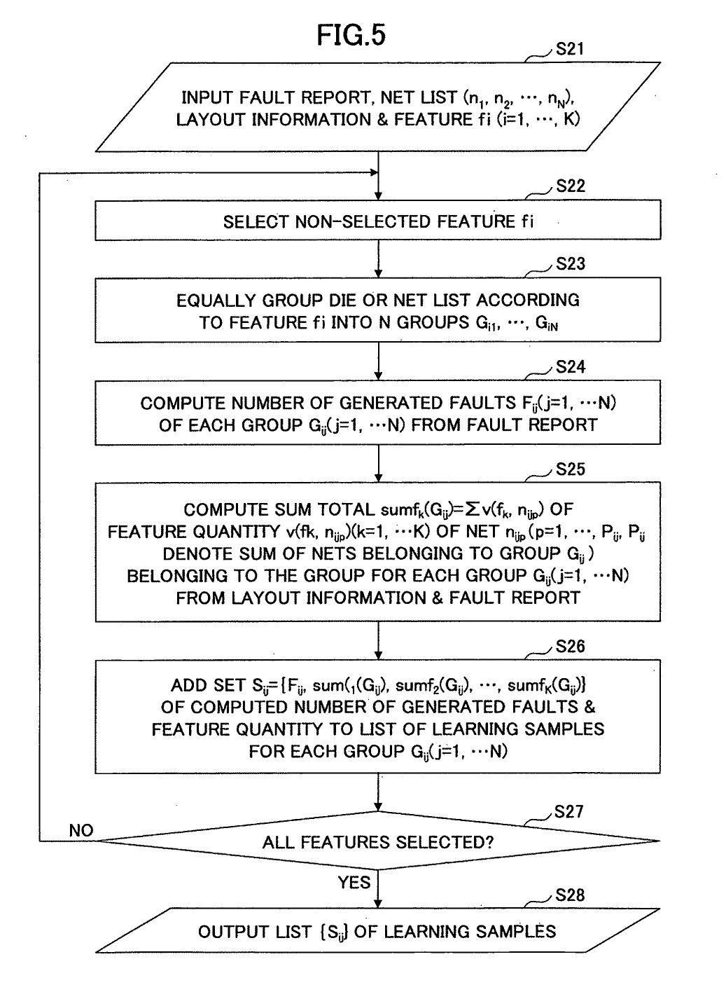

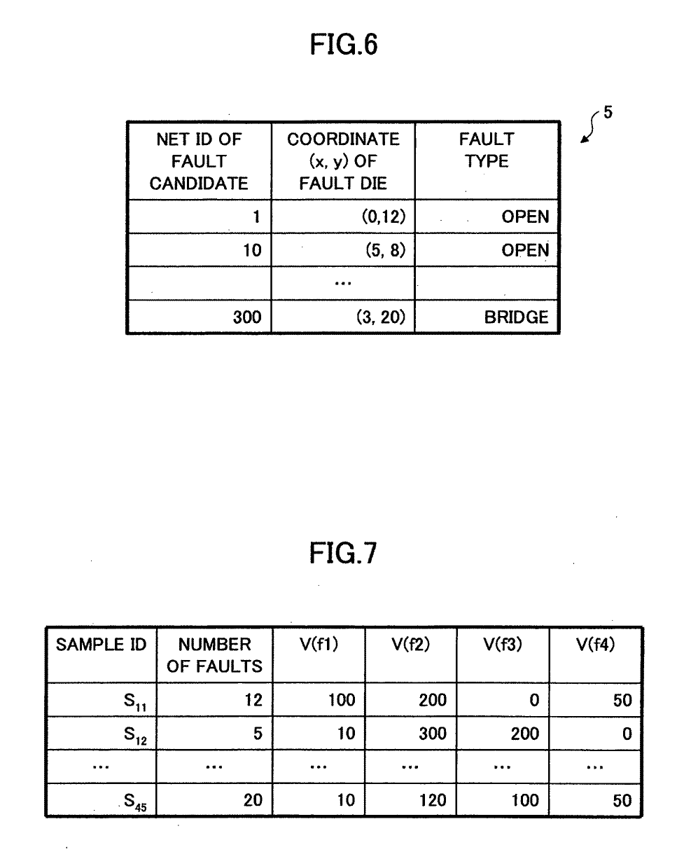

FIG. 5 is a flow chart for explaining an example of the process of the step S11 illustrated in FIG. 4 in more detail. In FIG. 5, a step S21 inputs the fault report 5, the circuit information 9 including the net lists (n₁, n₂, . . . , n_{N}) and the layout information, and the features fi (i=1, . . . , K) forming the feature list 50, by reading these information from the storage part 12, for example. The fault report 5 has a data structure illustrated in FIG. 6, for example. FIG. 6 is a diagram illustrating an example of the data structure of the fault report 5. The fault report 5 illustrated in FIG. 6 includes an ID (or net ID) of the net list of the fault candidates, a coordinate (x, y) of a fault die, and a fault type. However, only one of the net ID of the net list of the fault candidates and the coordinate (x, y) of the fault die may be included in the fault report 5, depending on whether the net lists are grouped (or divided) or the dies are grouped (or divided) in a step S23 which will be described later. The dies are obtained by cutting a wafer on which a plurality of semiconductor devices are formed, and each die is a wafer portion formed with the semiconductor device. Information of the dies may be included in the circuit information 9. For example, in the example illustrated in FIG. 6, the fault type is “open-circuit” in the case of the fault candidate having the net ID “10” for the net list of the fault candidates or, the fault candidate having the die coordinate (5, 8) for the coordinate (x, y) of the fault die.

A step S22 selects a non-selected feature fi. The step S23 groups (or equally divides) the net lists (n₁, n₂, . . . , n_{N}) or the dies into N groups Gᵢ₁, . . . , G_{iN} according to the selected feature fi. A step S24 computes a number of generated faults, Fᵢⱼ (j=1, . . . , N), of each group Gᵢⱼ (j=1, . . . , N) from the fault report 5. A step S25 computes a sum total sumfk(Gᵢⱼ)=Σv_{p=1 . . . Pij}(fk, nᵢⱼₚ) of the feature quantity v(fk, nᵢⱼₚ) (k=1, K) of the nets nᵢⱼₚ (p=1, . . . , Pᵢⱼ, where Pᵢⱼ denotes the number of nets belonging to each group Gij) belonging to each group Gᵢⱼ (j=1, . . . , N), for each group Gᵢⱼ, from the layout information and the fault report 5. A step S26 adds to the list of the learning samples a set Sᵢⱼ={Fᵢⱼ, sum(f1(Gᵢⱼ), sum(f2(Gᵢⱼ), . . . , sum(fk(Gᵢⱼ)} of the number of generated faults, Fᵢⱼ, and the feature quantity v(fk, nᵢⱼₚ) computed for each group Gᵢⱼ (j=1, . . . , N).

A step S27 judges whether all of the features fi have been selected, and the process returns to the step S22 if the judgement result in the step S27 is NO. On the other hand, if the judgement result in the step S27 is YES, a step S28 outputs a list of the learning samples, {Sᵢⱼ}. FIG. 7 is a diagram illustrating an example of a data structure of the learning sample list {Sᵢⱼ}.

FIG. 7 illustrates a list including a sum total V(fi) of the number of faults and the feature quantity of each net within each group Gᵢⱼ, with respect to a sample IDSᵢⱼ that is used to identify the sample. For example, there are features f1, f2, f3, and f4, and the number of features, K, is K=4. Suppose that the number of groups, N, to which the circuit information 9 is to be grouped is, N=5. In this case, if the nets n₁₁, n₁₂, and n₁₃ belong to the group obtained by the grouping for the feature f1, and the feature quantities related to the feature f₁ of each of the nets n₁₁, n₁₂, and n₁₃ are “30”, “40”, and “30”, respectively, the sum total V(f1) for the sample S₁₂ becomes V(f1)=30+40+30=100. The number of faults indicated in FIG. 7 corresponds to a target value of the learning process executed by the step S12 illustrated in FIG. 4. The list illustrated in FIG. 7 may be stored in the storage part 12.

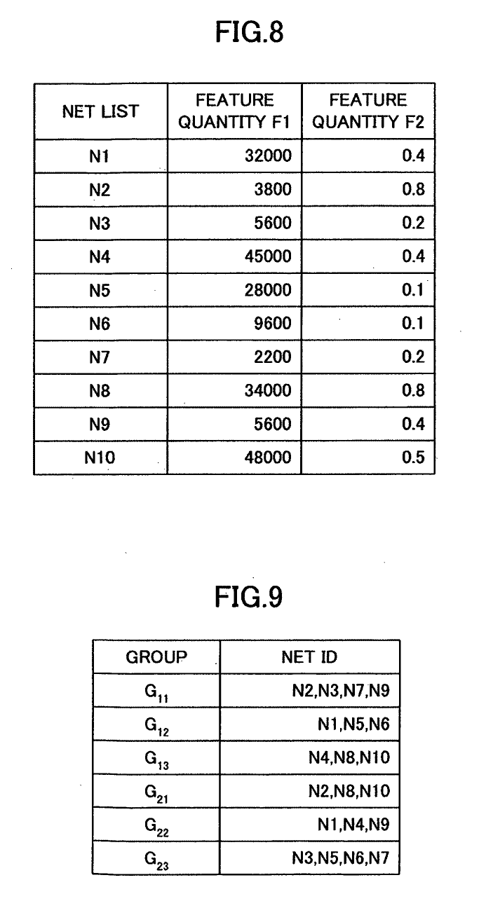

Next, a description will be given of an example of the grouping (that is, division into the groups) performed in the step S23 illustrated in FIG. 5, by referring to FIGS. 8 through 13.

In a first example of the grouping, the net lists of the circuit information 9 are sorted and grouped (or divided) according to the size of the feature quantity, and a known procedure is performed in which such a grouping is repeated for a plurality of features. FIG. 8 is a diagram illustrating an example of net lists each of which has two feature quantities. In FIG. 8, the feature quantity F1 of the net list N3 is “5600”, and the feature quantity F2 of the net list N3 is “0.2”. FIG. 9 is a diagram for explaining an example of generating 6 (3×2) groups from net lists in FIG. 8. In this case, for each of the feature quantities F1 and F2, the net lists are divided into 3 groups with the feature value. FIG. 9 illustrates an example in which the 3 groups are sorted in an ascending order of the feature quantities for each of the feature quantities F1 and F2. In FIG. 9, the net IDs of the net lists included in the group G11 are “N2, N3, N7, and N9”, for example, and in this case, the step S24 illustrated in FIG. 5 computes the number of faults generated in each of the groups G₁₁ through G₁₃ and groups G₂₁ through G₂₃ based on the information illustrated in FIG. 9. The data of the feature quantities F1 and F2 related to the net lists illustrated in FIG. 8, and the data of the net IDs of the net lists related to the groups illustrated in FIG. 9 may be stored in the storage part 12, for example.

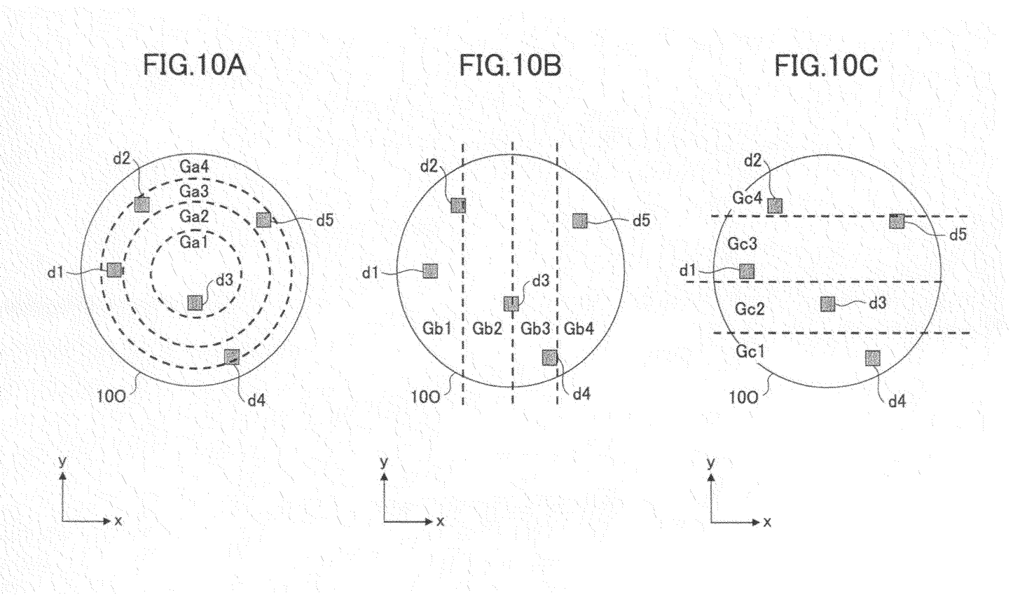

In a second example of the grouping, the grouping (or division) of the dies depending on the position on the wafer is performed a plurality of times. FIGS. 10A, 10B, and 10C are plan views illustrating regions of the dies on the wafer. FIG. 10A illustrates an example in which a wafer 100 is divided into 4 groups Gₐ₁ through Gₐ₄ depending on a distance from a center of the wafer 100. FIG. 10B illustrates an example in which the wafer 100 is divided into 4 groups G_{b1} through G_{b4} depending on a x-coordinate on the wafer 100. FIG. 10C illustrates an example in which the wafer 100 is divided into 4 groups G_{c1} through G_{c4} depending on a y-coordinate on the wafer 100. In FIGS. 10A through 10C, regions d1 through d5 indicated by shaded portions denote IDs of the fault dies. In this example, the wafer 100 is divided into'4 groups in the 3 manners illustrated in FIGS. 10A through 10C, and thus, the number of groups obtained by the divisions is 4×3=12.

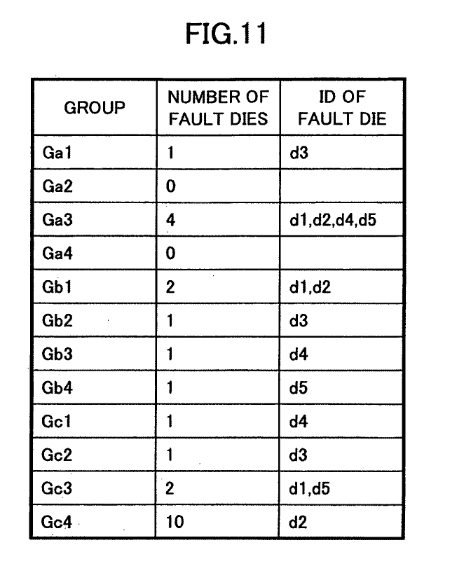

FIG. 11 is a diagram for explaining the number of generated faults computed by the step S24 illustrated in FIG. 5 in a case in which the grouping is performed according to the second example. In FIG. 11, the number of fault dies are computed as the number of faults generated, with respect to each group obtained by the grouping (or division), and the computed number of fault dies are stored in the storage part 12, for example, in relation to the IDs of the fault dies. For example, the number of fault dies in the group G_{b3} is “1”, and the ID of the fault die is “d4” in FIG. 11.

In a third example of the grouping, the grouping (or division) of the net lists depending on the wiring density is performed a plurality of times.

The wiring density is included in the circuit information 9, and may be included in the layout information. For example, if the number of wiring layers (or levels) of the semiconductor device is 5, and the net lists are grouped into 4 groups depending on the wiring density, such a grouping (or division) is performed for the number of wiring layers, that is, for the 5 layers. In this case, the number of groups is 4×5=20.

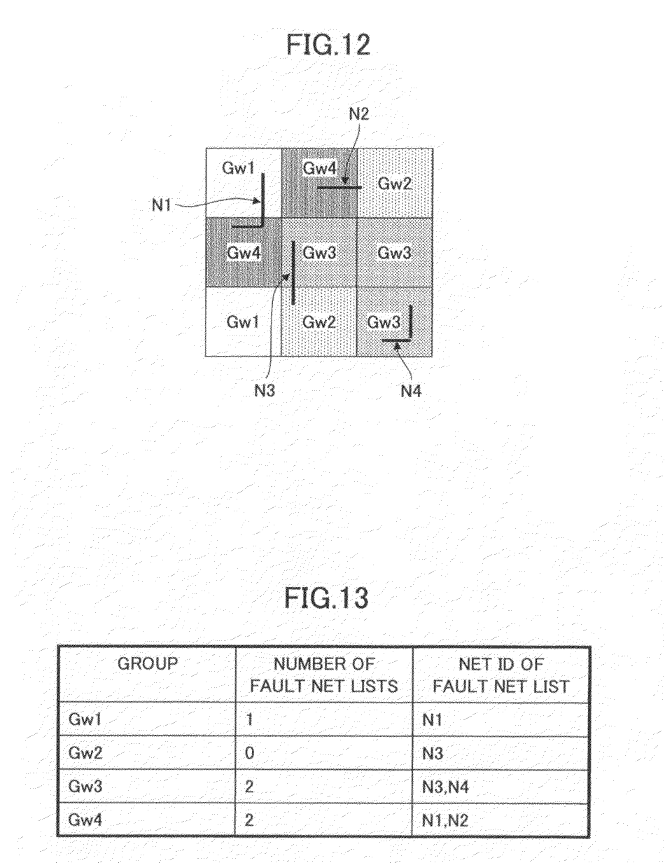

FIG. 12 is a diagram for explaining the grouping of the net lists according to the wiring density. For the sake of convenience, FIG. 12 illustrates an example of the grouping for one arbitrary wiring layer, and G_{w1} through G_{w4} denote the 4 groups that are obtained by this grouping. In addition, it is assumed for the sake of convenience in this example that the net IDs N1 through N4 of the net lists denote fault net lists. FIG. 13 is a diagram illustrating an example of the number of fault net lists and net IDs of the fault net lists included in the groups G_{w1} through G_{w4} obtained by the grouping for the one arbitrary wiring layer. For example, the number of fault net lists included in the group G_{w3} is “2”, and the net IDs of the fault net lists are “N3 and N4” in FIG. 13.

Of course, the method of grouping the circuit information 9, such as the net lists and the wiring densities, and the method of grouping the dies, are not limited to the first through third examples described above. It is of course possible to use a clustering technique typified by the K-means or, a technique that uses the decision tree, for the grouping (or division). An example of the clustering technique is proposed in “http://www.kamishima.net/jp/clustering/”, and an example of the technique that uses the decision tree is proposed in “http://ja.wikipedia.org/wiki/decision tree”. When the clustering technique or the technique that uses the decision tree is employed for the grouping, it may be possible to include information having strong tendencies within the same group.

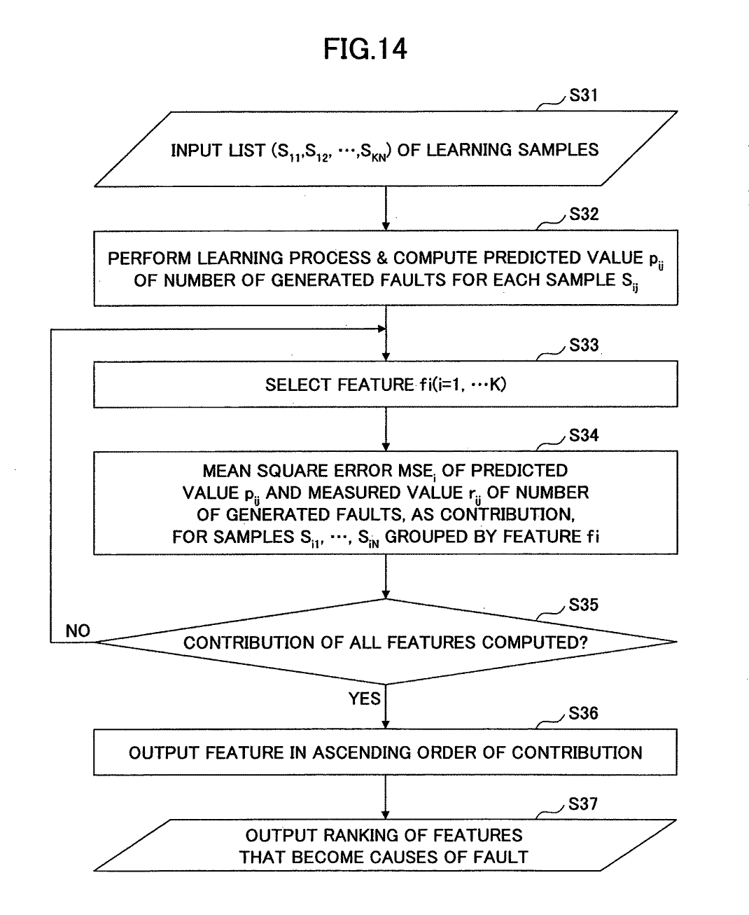

FIG. 14 is a flow chart for explaining an example of the process of the step S12 illustrated in FIG. 4 in more detail. In FIG. 14, a step S31 inputs the list of learned samples, {Sᵢⱼ}=(S₁₁, S₁₂, . . . , S_{KN}), generated in the step S11 illustrated in FIG. 4. The list of learned samples, {Sᵢⱼ}=(S₁₁, S₁₂, . . . , S_{KN}), may be input by reading the list of learned samples from the storage part 12, for example. A step S32 performs a known learning process, and computes the predicted value pᵢⱼ of the number of generated faults of each sample Sᵢⱼ, using a technique such as the SVM. A step S33 selects a non-selected feature fi (i=1, K).

A step S34 computes a MSE (Mean Square Error) MSEᵢ=Σ(pᵢⱼ−rᵢⱼ)² of the predicted value pᵢⱼ of the number of generated faults and the measured value rᵢⱼ of the number of generated faults, for the samples Sᵢ₁, . . . , S_{iN} that are grouped for the feature fi, and regards the MSEᵢ as the contribution of the feature fi to the fault. The measured value rᵢⱼ of the number of generated faults corresponds to the number of faults illustrated in FIG. 7, for example. A step S35 judges whether the contribution to the fault is computed for all of the features fi, and the process returns to the step S33 if the judgement result in the step S35 is NO.

On the other hand, if the judgement result in the step S35 is YES, a step S36 sorts the features according to the descending order of the contribution, for example, and outputs only the features having a relatively high contribution that is greater than or equal to a predetermined value, in order to narrow down the features that become the causes of the fault. A step S37 outputs the cause-of-fault information 7 that includes the narrowed down features that become the causes of the fault, and indicates the ranking of the features having the relatively high contribution to the fault obtained by the sorting made in the step S36. The format with which the cause-of-fault information 7 is output is not limited to a particular format. The cause-of-fault information 7 that is output may be stored in the storage part 12, for example.

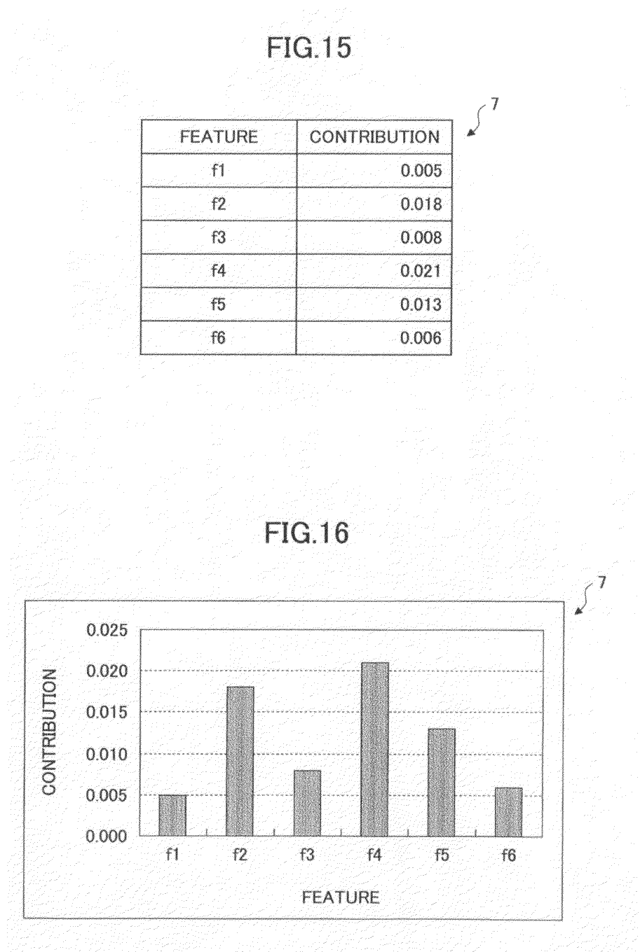

FIG. 15 is a diagram illustrating an example of cause-of-fault information 7 that is output by the step S37. FIG. 15 illustrates the cause-of-fault information 7 for a case in which the contribution of the features f1 through f6 to the fault is output in a table format. From the table of FIG. 15, it may be seen that the contribution of the feature f1 to the fault is “0.005”. Although FIG. 15 indicates the features f1 through f6 in this order, it is of course possible to indicate the features f1 through f6 in the descending order of the contribution, for example.

FIG. 16 is a diagram illustrating another example of the cause-of-fault information 7 that is output by the step S37. FIG. 16 illustrates the cause-of-fault information 7 for a case in which the contribution of the features f1 through f6 to the fault is output in a graph format. From the graph of FIG. 16, it may be seen that the contribution of the feature f1 to the fault is “0.005”. Although FIG. 16 indicates bar graphs of the features f1 through f6 in this order, it is of course possible to indicate the bar graphs of the features f1 through f6 in the descending order of the contribution, for example.

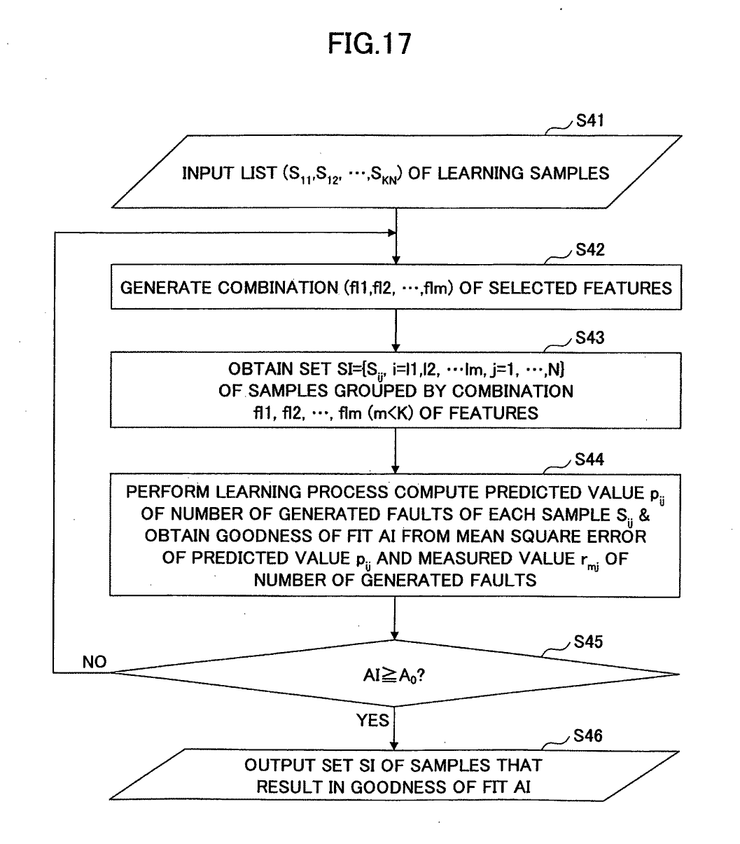

FIG. 17 is a flow chart for explaining another example of the process of the step S11 illustrated in FIG. 4 in more detail. In FIG. 17, a step S41 inputs the list of learned samples, {Sᵢⱼ}=(S₁₁, S₁₂, . . . , S_{KN}), generated in the step S11 illustrated in FIG. 4. The list of learned samples, {Sᵢⱼ}=(S₁₁, S₁₂, . . . , S_{KN}), may be input by reading the list of learned samples from the storage part 12, for example. A step S42 generates a combination (fl1, fl2, . . . , flm) of 2 or more features that are selected, where m<K. For example, an optimum combination (fl1, f12, . . . , flm) of 2 or more features may be generated according to a GA (Genetic Algorithm), for example. A step S43 computes a set SI of samples grouped according to the generated combination (fl1, fl2, . . . , flm) of 2 or more features, from SI={Sᵢⱼ, i=l1, l2, . . . , lm, j=1, . . . , N}.

A step S44 performs a known learning process to compute the predicted value pᵢⱼ of the number of generated faults of each sample Sᵢⱼ using the SVM, for example, and to compute a MSE (Mean Square Error) AI=Σ(pᵢⱼ−rₘⱼ)² of the predicted value pᵢⱼ of the number of generated faults and the measured value rₘⱼ of the number of generated faults. In addition, the step S44 regards the computed AI as the goodness of fit of the set SI of the samples. The goodness of fit, AI, corresponds to the contribution of the set SI of the samples to the fault, and the contribution to the fault is higher for higher goodness of fit, AI. A step S45 judges whether the goodness of fit, AI, is greater than or equal to a goodness of fit, A₀, having a predetermined value that is set in advance. The process returns to the step S42 if the judgement result in the step S45 is NO.

On the other hand, if the judgement result in the step S45 is YES, a step S46 narrows down the features that become the causes of the fault, by outputting only the set SI of the samples having the goodness of fit, AI, that is relatively high and is greater than or equal to the predetermined value (goodness of fit, A₀). In other words, the step S46 outputs the cause-of-fault information 7 that includes the combination of the narrowed features that become the causes of the fault, and indicate the ranking of the combination of the features having the relatively high contribution to the fault due to the goodness of fit, AI, that is greater than or equal to the predetermined value (goodness of fit, A₀). The format with which the cause-of-fault information 7 is output is not limited to a particular format. The cause-of-fault information 7 that is output may be stored in the storage part 12, for example. Hence, by extracting the set SI of the groups in which the goodness of fit, AI, between the predicted value and the measured value of the number of generated faults, is greater than or equal to the predetermined value, amongst the groups generated in the step S11 illustrated in FIG. 4, it may be possible improve the accuracy with which the fault candidates are extracted and to further improve the accuracy of the statistical analysis.

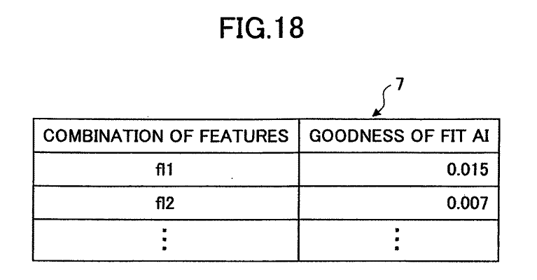

FIG. 18 is a diagram illustrating an example of the cause-of-fault information 7 output by the step S46. FIG. 18 illustrates the cause-of-fault information 7 for a case in which the contribution of the combination fl1, . . . of the features to the fault is output as the goodness of fit, AI, in a table format. From the table of FIG. 18, it may be seen that the goodness of fit, AI, indicating the contribution of the combination of features, fl1, to the fault is “0.005”. Of course, the cause-of-fault information 7 may be output with a graph format. In addition, although FIG. 18 indicate the combination of features fl1, . . . in this order, it is of course possible to indicate the combination of features, fl1, . . . in the descending order of the goodness of fit, AI, for example.

According to the embodiment described above, the volume diagnosis process 6 may narrow down the causes of the fault by the statistical analysis, even in a case in which the number of faults obtained from the fault report 5 output by the fault analyzing process 4 is relatively small. As a result, the fault candidates may be extracted with a high accuracy, and the accuracy of the statistical analysis may be prevented from deteriorating.

Although the embodiments are numbered with, for example, “first,” “second,” or “third,” the ordinal numbers do not imply priorities of the embodiments. Many other variations and modifications will be apparent to those skilled in the art.

All examples and conditional language recited herein are intended for pedagogical purposes to aid the reader in understanding the invention and the concepts contribute by the inventor to furthering the art, and are to be construed as being without limitation to such specifically recited examples and conditions, nor does the organization of such examples in the specification related to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A fault diagnosis method to be implemented in a computer to execute a fault diagnosis of a semiconductor device to perform a statistical analysis based on a fault report including information of nets or input and output pins that become fault candidates, and features that become fault candidates, said fault diagnosis method comprising:
grouping circuit information of the semiconductor device into N (N is a natural number greater than or equal to 2) groups using one kind of feature as an index, for K (K is a natural number greater than or equal to 2) kinds of features, in order to group the circuit information into K×N groups, and to compute a sum total of feature quantities of partial circuits belonging to each of the groups and to output a computed result in a form of a list of learning samples; and
computing a contribution of each feature to the fault by a learning process based on the list of the learning samples, and to compute a ranking of the features having the contribution greater than or equal to a predetermined value in order to output and store in a storage part cause-of-fault information that includes the causes of the fault and indicate the ranking of the features.

2. The fault diagnosis method as claimed in claim 1, wherein the computing the contribution outputs the cause-of-fault information by extracting a set of the learning samples having a goodness of fit between a predicted value and a measured value of a number of generated faults that is greater than or equal to a predetermined value, amongst the K×N groups.

3. The fault diagnosis method as claimed in claim 2, wherein the computing the contribution includes:
generating a combination of 2 or more features to be selected;
computing a set of leaning samples that are grouped according to the combination of the 2 or more features; and
performing the learning process to compute the predicted value of the number of generated faults of each learning sample and to compute a MSE (Mean Square Error) of the predicted value of the number of generated faults and the measured value of the number of generated faults, in order to obtain a goodness of fit of the set of the learning samples.

4. The fault diagnosis method as claimed in claim 1, wherein the grouping circuit information includes:
computing a sum total sumfk(Gᵢⱼ)=Σv_{p=1 . . . Pij}(fk, nᵢⱼₚ) of a feature quantity v(fk, nᵢⱼₚ) (k=1, . . . , K) of nets nᵢⱼₚ (p=1, . . . , Pᵢⱼ) belonging to each group Gᵢⱼ (j=1, . . . , N), for each group Gᵢⱼ, from the layout information and the fault report of the semiconductor device, where Pᵢⱼ denotes a number of nets belonging to each group Gij; and
adding to the list of the learning samples a set Sᵢⱼ={Fᵢⱼ, sum(f1(Gᵢⱼ), sum(f2(Gᵢⱼ), . . . , sum(fk(Gᵢⱼ)} of the number of generated faults, Fᵢⱼ, and the feature quantity v(fk, nᵢⱼₚ) computed for each group Gᵢⱼ (j=1, . . . , N).

5. The fault diagnosis method as claimed in claim 1, wherein the grouping the circuit information includes:
repeating a process of sorting and grouping net lists of the circuit information according to a size of a feature quantity for a plurality of features;
repeating a process of grouping dies depending on locations on a wafer where the semiconductor device is formed; and
repeating a process of grouping the net list according to a wiring density of the semiconductor device.

6. A fault diagnosis apparatus configured to execute a fault diagnosis of a semiconductor device to perform a statistical analysis based on a fault report including information of nets or input and output pins that become fault candidates, and features that become fault candidates, said fault diagnosis apparatus comprising:
a first unit configured to perform a process of grouping circuit information of the semiconductor device into N (N is a natural number greater than or equal to 2) groups using one kind of feature as an index, for K (K is a natural number greater than or equal to 2) kinds of features, in order to group the circuit information into K×N groups, and to compute a sum total of feature quantities of partial circuits belonging to each of the groups and to output a computed result in a form of a list of learning samples; and
a second unit configured to perform a learning process based on the list of the learning samples in order to compute a contribution of each feature to the fault, and to compute a ranking of the features having the contribution greater than or equal to a predetermined value in order to output and store in the storage part cause-of-fault information that includes the causes of the fault and indicate the ranking of the features.

7. The fault diagnosis apparatus as claimed in claim 6, wherein the second unit outputs the cause-of-fault information by extracting a set of the learning samples having a goodness of fit between a predicted value and a measured value of a number of generated faults that is greater than or equal to a predetermined value, amongst the K×N groups.

8. The fault diagnosis apparatus as claimed in claim 7, wherein the second unit includes:
a part configured to generate a combination of 2 or more features to be selected;
a part configured to compute a set of leaning samples that are grouped according to the combination of the 2 or more features; and
a part configured to perform the learning process to compute the predicted value of the number of generated faults of each learning sample and to compute a MSE (Mean Square Error) of the predicted value of the number of generated faults and the measured value of the number of generated faults, in order to obtain a goodness of fit of the set of the learning samples.

9. The fault diagnosis apparatus as claimed in claim 6, wherein the first unit includes:
a part configured to compute a sum total sumfk(Gᵢⱼ)=Σv_{p=1 . . . Pij}(fk, nᵢⱼₚ) of a feature quantity v(fk, nᵢⱼₚ) (k=1, K) of nets nᵢⱼₚ (p=1, . . . , Pᵢⱼ) belonging to each group Gᵢⱼ (j=1, . . . , N), for each group Gᵢⱼ, from the layout information and the fault report of the semiconductor device, where Pᵢⱼ denotes a number of nets belonging to each group Gij; and
a part configured to add to the list of the learning samples a set Sᵢⱼ={Fᵢⱼ, sum(f1(Gᵢⱼ), sum(f2(Gᵢⱼ), sum(fk(Gᵢⱼ)} of the number of generated faults, Fᵢⱼ, and the feature quantity v(fk, nᵢⱼₚ) computed for each group Gᵢⱼ (j=1, . . . , N).

10. The fault diagnosis apparatus as claimed in claim 6, wherein the first unit performs a process selected from a group consisting of:
a process to repeat a process of sorting and grouping net lists of the circuit information according to a size of a feature quantity for a plurality of features;
a process to repeat a process of grouping dies depending on locations on a wafer where the semiconductor device is formed; and
a process to repeat a process of grouping the net list according to a wiring density of the semiconductor device.

11. A fault diagnosis apparatus configured to execute a fault diagnosis of a semiconductor device to perform a statistical analysis based on a fault report including information of nets or input and output pins that become fault candidates, and features that become fault candidates, said fault diagnosis apparatus comprising:
a processor configured to execute a procedure, the procedure comprising:
grouping circuit information of the semiconductor device into N (N is a natural number greater than or equal to 2) groups using one kind of feature as an index, for K (K is a natural number greater than or equal to 2) kinds of features, in order to group the circuit information into K×N groups, and to compute a sum total of feature quantities of partial circuits belonging to each of the groups and to output a computed result in a form of a list of learning samples; and
computing a contribution of each feature to the fault by a learning process based on the list of the learning samples, and to compute a ranking of the features having the contribution greater than or equal to a predetermined value in order to output and store in a storage part cause-of-fault information that includes the causes of the fault and indicate the ranking of the features.

12. A computer-readable, non-transitory medium storing a program which causes a computer to execute a procedure, the procedure comprising:
grouping circuit information of the semiconductor device into N (N is a natural number greater than or equal to 2) groups using one kind of feature as an index, for K (K is a natural number greater than or equal to 2) kinds of features, in order to group the circuit information into K×N groups, and to compute a sum total of feature quantities of partial circuits belonging to each of the groups and to output a computed result in a form of a list of learning samples; and
computing a contribution of each feature to the fault by a learning process based on the list of the learning samples, and to compute a ranking of the features having the contribution greater than or equal to a predetermined value in order to output and store in a storage part cause-of-fault information that includes the causes of the fault and indicate the ranking of the features.

13. The computer-readable, non-transitory medium as claimed in claim 12, wherein the computing the contribution outputs the cause-of-fault information by extracting a set of the learning samples having a goodness of fit between a predicted value and a measured value of a number of generated faults that is greater than or equal to a predetermined value, amongst the K×N groups.

14. The computer-readable, non-transitory medium as claimed in claim 13, wherein the computing the contribution includes:
generating a combination of 2 or more features to be selected;
computing a set of leaning samples that are grouped according to the combination of the 2 or more features; and
performing the learning process to compute the predicted value of the number of generated faults of each learning sample and to compute a MSE (Mean Square Error) of the predicted value of the number of generated faults and the measured value of the number of generated faults, in order to obtain a goodness of fit of the set of the learning samples.

15. The computer-readable, non-transitory medium as claimed in claim 12, wherein the grouping the circuit information includes:
computing a sum total sumfk(Gᵢⱼ)=Σv_{p=1 . . . Pij}(fk, nᵢⱼₚ) of a feature quantity v(fk, nᵢⱼₚ) (k=1, . . . , K) of nets nᵢⱼₚ (p=1, . . . , Pᵢⱼ) belonging to each group Gᵢⱼ (j=1, . . . , N), for each group Gᵢⱼ, from the layout information and the fault report of the semiconductor device, where Pᵢⱼ denotes a number of nets belonging to each group Gij; and
adding to the list of the learning samples a set Sᵢⱼ={Fᵢⱼ, sum(f1(Gᵢⱼ), sum(f2(Gᵢⱼ), . . . , sum(fk(Gᵢⱼ)} of the number of generated faults, Fᵢⱼ, and the feature quantity v(fk, nᵢⱼₚ) computed for each group Gᵢⱼ (j=1, . . . , N).

16. The computer-readable, non-transitory medium as claimed in claim 12, wherein the grouping the circuit information includes:
repeating a process of sorting and grouping net lists of the circuit information according to a size of a feature quantity for a plurality of features;
repeating a process of grouping dies depending on locations on a wafer where the semiconductor device is formed; and
repeating a process of grouping the net list according to a wiring density of the semiconductor device.
